(19) United States
(12) Patent Application Publication
(10) Pub. No.: US 2009/0096291 A1
(43) Pub. Date: Apr. 16, 2009

(54) Power Supply Control

(75) Inventors: Maurice Gainville, Saint Martin en Campagne (FR); Philippe Marquet, Saint Nicolas d'Aliermont (FR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: EPIQ, Montigny le Bretonneux (FR)

(21) Appl. No.: 11/793,912

(22) PCT Filed: Dec. 21, 2005
(86) PCT No.: PCT/IB05/03847

§ 371 Date: Sep. 2, 2008

(30) Foreign Application Priority Data
Dec. 21, 2004 (FR) 0413671

(51) Int. Cl. H02J 3/14

(52) U.S. Cl. 307/41

(57) ABSTRACT

A domestic electric heating system (100) comprises a main electrical power feed (104) connected to distribution means (102). The distribution means (102) allows electrical power to be switched via power connections (110, 120, 130, 140) to heaters (111, 121, 121, 141), each located within a separate room or area (115, 125, 135, 145) of the domestic dwelling. Control means (101), contains processing means (105) configured to allocate the available electrical power from the power feed (104) in accordance with distribution parameters entered by use of input means (103). The power used is reduced by only distributing power to a limited number of the heaters (111, 121, 131, 141) at any one time. The power can be distributed proportionally between heaters (111, 121, 131, 141) by distributing power to certain of the heaters in turn according to a cyclical sequence.

The present invention relates to a method of controlling domestic power consumption within prescribed limits.

Power suppliers aim to supply the entire demanded power load at all times. The demanded load varies with weather, time of day, season and other occasional factors such as sporting events or television programs. Solutions to this problem range from having large surplus capacity to strict or even draconian regulations concerning customers' individual peak load demand. Spare capacity is a costly solution whilst differential pricing rates do not necessarily limit the demand.

During normal working hours industrial power users traditionally work with power supply companies to manage the load demanded, and thus endeavour to keep the load at a smooth and relatively constant level. In the evening and overnight when demand from industrial users falls, demand on a power supply may become dominated by domestic users. Peaks and troughs in such domestic demand are less predictable and controllable and can thus lead to widely variable and even excessive demand which must be met by the supply companies.

Within domestic demand a major factor is the use of electricity for heating. Domestic electric heaters typically have thermostats allowing users to set a desired target temperature. The desired temperature is controlled by varying the current passed through a heating element in response to measurement of the local temperature. As this is the case, depending on the difference between the local temperature and the desired temperature, total loading called for by electric heaters in an individual dwelling can vary from zero to a maximum of 50 or 60 amperes.

Some solutions have previously been proposed. For example: WO 03/008983 teaches measuring a users consumption and then disconnecting said user when their consumption exceeds a preset limit; and RU2193812 teaches a scheme in which a power supplier can transmit a radio signal to a user in order to set a limit for consumption and once the users consumption exceeds this limit, the user is disconnected.

According to a first aspect of the present invention there is provided an apparatus for allocating a power supply to a plurality of devices comprising: a power supply; distribution means for distributing supplied power to individual devices; and control means for controlling the distribution means wherein the distribution means is operable to distribute power to the devices in a cyclical sequence, said sequence being divided into a plurality of time slots wherein in each time slot, power is distributed to a limited number of the devices.

According to a second aspect of the present invention there is provided a method of allocating a limited power supply between a plurality of devices comprising the steps of: distributing power to the devices in a cyclical sequence, said sequence being divided into a plurality of time slots wherein in each time slot, power is distributed to a limited number of the devices.

The present invention thereby provides a method and apparatus whereby input power can be allocated between a plurality of devices in such a manner as to present a near constant load on the input power supply. Such a method and apparatus may be conveniently be used to allocate power within domestic dwellings to prevent the overloading of input power supply.

The power supply may have a limit placed upon it by a user or an external authority such as the power supplier. Preferably the distribution of power to a limited number of said devices in any single time slot is arranged so that the maximum current in delivered in any time slot does not exceed the maximum permitted input power level.

Preferably, the power supply comprises a processing means operable to determine which devices should be powered during each time slot of the cycle. The processing means may calculate which devices should be powered by considering preset distribution parameters. The preset distribution parameters may be adjusted by use of an input means connected to said control means. If said parameters are adjusted the number of devices powered during each time slot in the cycle, the number of timeslots in which a device is powered or the total number of time slots in a cycle may be varied.

In one preferred embodiment, the devices are electric heaters provided in a domestic dwelling and the power supply is the mains power supply. In such embodiments, the control means is preferably connected to feedback means provided in the vicinity of each heater for monitoring the local temperature. The feedback means may comprise any suitable form of electronic temperature sensing means. The heaters may be arranged to heat rooms, directly or indirectly and/or to heat a water supply.

In such embodiments, the preset distribution parameters may include a target temperature for the vicinity of each heater and or a priority level for each heater. The processing means may then be operable to determine the overall distribution of power for each cycle on the basis of the target temperature, the priority level and the actual temperature measured by the feedback means for each heater.

Preferably the input means is also provided with a display means for displaying any or all of: target temperature settings; priority levels; local temperature as measured by the feedback means; actual power consumption; maximum permitted power consumption; or estimated time to achieve targets temperature; or any other such data or processed information as may be felt relevant, helpful or instructive to the user.

The maximum permitted power may be altered by the user or by the power supply authority. This may be achieved by the user inputting suitable parameters into the input means. The power consumption may be further limited by the user or the supply authority to a maximum total cost of consumed power within a specified period.

In an alternative preferred embodiment of the invention one or more of the devices may be heating means powered by an alternative source such as gas or oil, said heating means being responsive to power control signals from the control means. The maximum permitted power consumption may then be set by the user to be shared between these two or more sources of power if desired. This may facilitate the user minimising the cost of power by balancing consumption across two or more suppliers or may facilitate compensating for a lack of availability of one or more supplies.

In a further preferred embodiment the control means is responsive to inputs from detectors arranged to detect the presence or absence of persons within all or part of the domestic dwelling. The control means may thus be operable to modify the target temperature settings or the priority setting of a load in response to the location, presence or absence of an occupier. Additionally or alternatively, the control means may be responsive to signals indicative of the open or closed states of windows, doors or other apertures that may cause loss of heat from one or more room or area of the dwelling. The signals may be provided by suitable detectors. The detectors may be detectors forming part of an alternative system such as a burglar or fire alarm or may be separate dedicated detectors. In some embodiments such detectors may be combined with the feedback means.

In a preferred embodiment of the invention the feedback means comprises individual temperature sensors each mounted within a temperature separable area of the domestic premises. The feedback means and/or detectors may be wired directly to the control means or may be connected to the control means by any other suitable signalling means such as RF signals transmitted through the air, along electrical power cables or along other cables such as the “pilote” connections sometimes available in French installations.

In a further preferred embodiment of the invention the control means is further arranged to determine and store data relating to the thermal inertia of one or more of the separable rooms or areas of the premises and to be responsive to said stored data when determining the instantaneous allocation of power to the individual loads.

In a further preferred embodiment of the invention the control means is arranged to determine and store data relating to the outside temperature and the season and to be responsive to said stored data when determining the instantaneous allocation of power to the individual loads.

In a further preferred embodiment of the invention the control means is further responsive to data transmitted to it via the internet or a cellular telephone network (by text message, data message or otherwise) when determining the instantaneous allocation of power to the individual loads.

In further alternative embodiments, the individual devices may be provided with subsidiary control means operable in response to signals received from the control means to enable said device to draw a load from the power supply only during specified time slots. Said signals may be sent prior to each time slot. In some embodiments the subsidiary control means may incorporate memory means. The memory means may store information relating to whether a device is to be switched on in a particular slot such that the device only draws power in appropriate time slots in each sequence. In such embodiments, signalling may take place prior to each time slot, prior to each sequence or at any other desired time interval. The signals may be individually addressed to said devices. Additionally or alternatively, said signalling may be addressed to all devices with a particular priority setting.

In order that the invention be more clearly understood, one embodiment is now described in greater detail below, by way of example only and with reference to the drawings in which:—

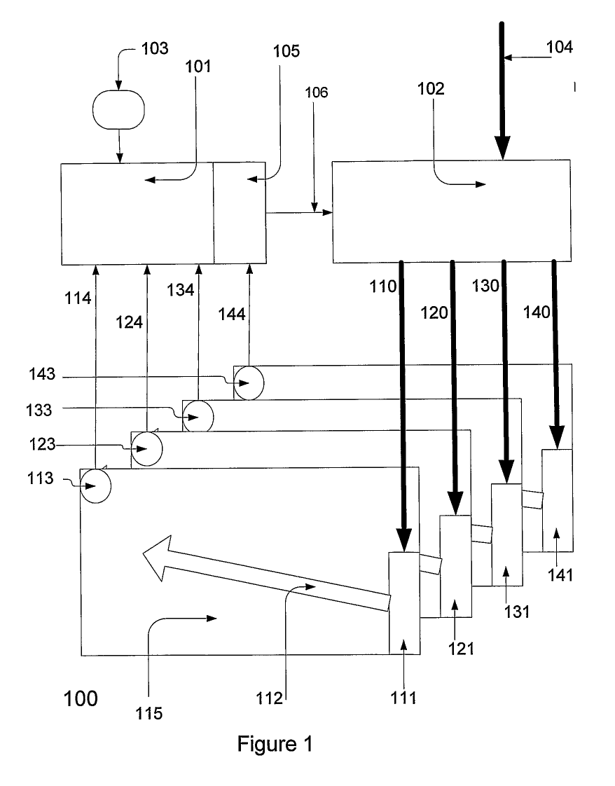

FIG. 1 is a schematic block diagram of a heating system incorporating an apparatus according to the present invention;

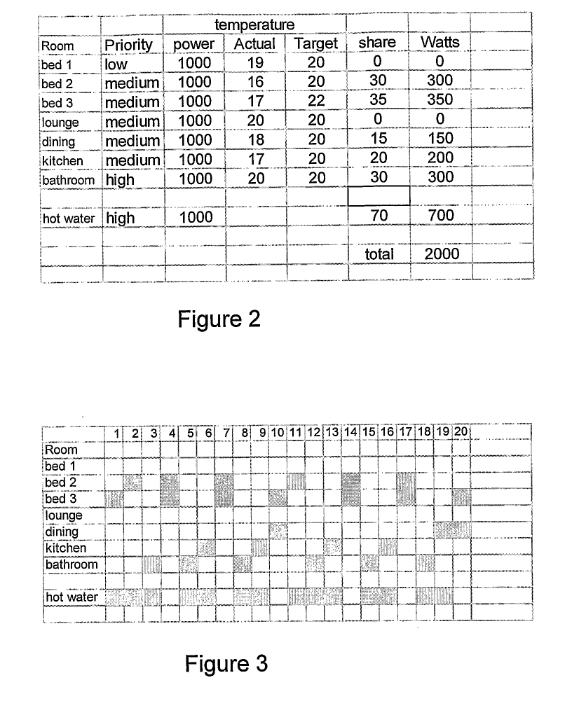

FIG. 2 is a list of distribution parameters used in the operation of the heating system of FIG. 1; and

FIG. 3 indicates how power is distributed to individual heaters during a single cycle.

Referring now to FIG. 1, a domestic electric heating system 100 comprises a main electrical power feed 104 connected to distribution means 102. The distribution means 102 allows electrical power to be switched via power connections 110, 120, 130, 140 to heaters 111, 121, 121, 141, each located within a separate room or area 115, 125, 135, 145 of the domestic dwelling.

Within each room 115, 125, 135, 145, heat 112, 122, 132, 142 output by the heaters 111, 121, 131, 141 is detected by feedback means 113, 123, 133, 143. The feedback means 113, 123, 133, 143 are operable to transmit a signal 114, 124, 134, 144 to control means 101 indicative of the temperature within the room 115, 125, 135, 145.

Control means 101, contains processing means 105 configured to allocate the available electrical power from the power feed 104 in accordance with distribution parameters entered by use of input means 103. The distribution parameters may comprise any one or more of a target temperature for each room, a priority for each room, an overall spend limit for a predetermined time period (week, month, quarter etc.) and any other such parameters as may be deemed necessary or desirable for the specific application. These parameters may also be adjusted by means of signals received from external units, such as a users mobile telephone or by detectors provided in said room operable to determine such parameters as the occupation of the room and whether doors/windows in the room are open or shut. These detectors may be dedicated detectors or may form part of a separate system such as a burglar alarm.

The processing means is operable to distribute the available input power to the heaters 111, 121, 131, 141. If there is sufficient input power for each heater to be operated at its desired capacity, this is done. If there is not sufficient input power for each heater to operate at full capacity, the processing means calculates how to allocate the available input power between the heaters 111, 121, 131, 141 so as to try to achieve the target temperatures of each heater 111, 121, 131, 141 or to at least achieve the target temperature for the highest priority heater. In this manner the heaters 111, 121, 131, 141 are individually connected or disconnected to the power feed 104. This allows the instantaneous power used to be limited whilst still maintaining the desired target temperature in each room.

The power used is reduced by only distributing power to a limited number of the heaters 111, 121, 131, 141 at any one time. The power can be distributed proportionally between heaters 111, 121, 131, 141 by distributing power to certain of the heaters in turn according to a cyclical sequence. This is explained in greater detail below.

FIG. 2 shows a list of rooms and other spaces to be heated (in this case a hot water tank) rooms and distribution parameters for each of the rooms. In the example shown, the rooms each have a target temperature and a priority rating. The processing means receives signals from each feedback means indicating the actual temperature in each room. On the basis of the difference between actual temperature and target temperature, the processing means controls the distribution of power between the individual heaters. The distribution of power is indicated here by percentage share and by effective wattage.

FIG. 3 indicates how such an allocation of power between heaters as shown in FIG. 2 can be achieved. Power is distributed to the heaters in a repetitive cycle. In the example shown the cycle is split into twenty equal time slots, the heaters switched on in any time slot being indicated by a shaded block in FIG. 3. In the example only two loads are powered in any time slot thus limiting the overall power distributed at any one time to 2 kW compared to a possible peak of 8 kW.

In order that the heaters maintain a constant temperature and thus avoid problems resulting from repeated inrush currents associated with reheating cooled loads, the time slots are short. Typically the time slots are of the order of a few cycles of the AC mains supply in length.

In an alternative embodiments, each heater 111, 121, 131, 141 may incorporate a subsidiary control means (not shown) operable to allow the heater to be connected or disconnected to the power feed. The connection may be enabled only at certain specified time slots within a cycle, as determined by the processing means. The subsidiary control means may be operable to connect or disconnect particular heaters 111, 121, 131, 141 in response to signals transmitted from the control unit before each time slot. Alternatively, before each cycle, the control means may transmit information to each subsidiary control means relating to which time slots it is to enable connection or disconnection of its heater 111, 121, 131, 141. These signals may be RF signals sent either wirelessly or along said power supply or may be sent along a dedicated connection such as a ‘pilote’ connection.

It is of course to be understood that the invention is not to be restricted to the details of the above embodiment which is described by way of example only.

1. An apparatus for allocating a power supply to a plurality of devices comprising: a power supply; distribution means for distributing supplied power to individual devices; and control means for controlling the distribution means wherein the distribution means is operable to distribute power to the devices in a cyclical sequence, said sequence being divided into a plurality of time slots wherein in each time slot, power is distributed to a limited number of the devices.

2. An apparatus as claimed in claim 1 wherein the power supply has a limit placed upon it.

3. An apparatus as claimed in claim 2 wherein the limit is placed upon the power supply by a user or by an external authority.

4. An apparatus as claimed in claim 1 wherein the power consumption is limited to a maximum total cost of consumed power within a specified period.

5. An apparatus as claimed in claim 1 wherein the control means is responsive to data transmitted to it via the internet or a cellular telephone network (by text message, data message or otherwise) when determining the instantaneous allocation of power to the individual loads.

6. An apparatus as claimed in any preceding claim 1 wherein one or more of the devices are heating devices powered by an alternative source such as gas or oil, said heating devices being responsive to power control signals from the control means and wherein the control means is operable to allow power consumption to be shared between these two or more sources of power.

7. An apparatus as claimed in claim 1 wherein the distribution of power to a limited number of said devices in any single time slot is arranged so that the maximum current in delivered in any time slot does not exceed a maximum permitted input power level.

8. An apparatus as claimed in claim 1 wherein the power supply comprises a processing means operable to determine which devices should be powered during each time slot of the cycle.

9. An apparatus as claimed in claim 8 wherein the processing means calculates which devices should be powered by considering preset distribution parameters.

10. An apparatus as claimed in claim 9 wherein the preset distribution parameters are adjusted by use of an input means connected to said control means.

11. An apparatus as claimed in claim 10 wherein if said parameters are adjusted the number of devices powered during each time slot in the cycle, the number of timeslots in which a device is powered or the total number of time slots in a cycle are varied.

12. An apparatus as claimed in claim 1 wherein the devices are electric heaters provided in a domestic dwelling and the power supply is the mains power supply.

13. An apparatus as claimed in claim 12 wherein the control means is connected to feedback means provided in the vicinity of each heater for monitoring the local temperature.

14. An apparatus as claimed in claim 13 wherein the feedback means comprises an electronic temperature sensing means.

15. An apparatus as claimed in claim 13 wherein the distribution parameters may include a target temperature for the vicinity of each heater and or a priority level for each heater.

16. An apparatus as claimed in claim 12 wherein the control means is responsive to inputs from detectors arranged to detect the presence or absence of persons within all or part of the domestic dwelling.

17. An apparatus as claimed in claim 16 wherein the control means is operable to modify a target temperature settings or a priority setting of a load in response to the location, presence or absence of an occupier.

18. An apparatus as claimed in claim 12 wherein the control means is responsive to signals indicative of the open or closed states of windows, doors or other apertures that may cause loss of heat from one or more room or area of the dwelling.

19. An apparatus as claimed in claim 16 wherein the detectors form part of an alternative system including one of as a burglar or fire alarm.

20. An apparatus as claimed in claim 16 wherein the detectors are dedicated detectors.

21. An apparatus as claimed in claim 16 wherein the detectors are combined with the feedback means.

22. An apparatus as claimed in claim 13 wherein the detectors and/or the feedback means are connected to the control means by signalling means selected from the set of: RF signals transmitted through the air, along electrical power cables or along “pilote” connections.

23. An apparatus as claimed in claim 12 wherein the control means is further arranged to determine and store data relating to the thermal inertia of one or more of the separable rooms or areas of the premises and to be responsive to said stored data when determining the instantaneous allocation of power to the individual loads.

24. An apparatus as claimed in claim 12 wherein the control means is arranged to determine and store data relating to the outside temperature and the season and to be responsive to said stored data when determining the instantaneous allocation of power to the individual loads.

25. An apparatus as claimed in claim 15 wherein the processing means is operable to determine the overall distribution of power for each cycle on the basis of the target temperature, the priority level and an actual temperature measured by the feedback means for each heater.

26. An apparatus as claimed in claim 15 further including a display means for displaying any or all of: target temperature settings; priority levels; local temperature as measured by the feedback means; actual power consumption; maximum permitted power consumption; or estimated time to achieve target temperature.

27. An apparatus as claimed in claim 1 wherein the individual devices are provided with subsidiary control means operable in response to signals received from the control means to enable said device to draw a load from the power supply only at specified time slots within a sequence.

28. An apparatus as claimed in claim 27 wherein said signals are sent prior to each time slot indicating to each device whether this is a specified time slot.

29. An apparatus as claimed in claim 27 wherein the subsidiary control means includes a memory and the memory stores information relating to whether a device is to be switched on in a particular slot such that the device only draws power in particular specified time slots in each sequence.

30. An apparatus as claimed in claim 29 wherein signalling takes place prior to each sequence.

31. An apparatus as claimed in claim 27 wherein the signals are individually addressed to said devices.

32. A method of allocating a limited power supply between a plurality of devices comprising the steps of: distributing power to the devices in a cyclical sequence, said sequence being divided into a plurality of time slots wherein in each time slot, power is distributed to a limited number of the devices.

33. A method as claimed in claim 32 wherein the distribution of power to a limited number of said devices in any single time slot is arranged so that the maximum current in delivered in any time slot does not exceed a maximum permitted input power level.

34. A method as claimed in claim 33 wherein which devices should be powered in any one time slot is calculated by considering one or more preset distribution parameters.

35. A method as claimed in claim 34 wherein the preset distribution parameters are adjustable.

36. A method as claimed in claim 32 wherein the individual devices are operable in response to signals received from the control means to enable said device to draw a load from the power supply only at specified time slots within a sequence.
